(19) United States
(12) Patent Application Publication
(10) Pub. No.: US 2020/0320547 A1
(43) Pub. Date: Oct. 8, 2020

(54) Efficient Object Slotting

(71) Applicant: 1A Auto, Inc., Westford, MA (US)

(72) Inventor: Jorge Isaac Chavez, Medford, MA (US)

(21) Appl. No.: 16/373,097

(22) Filed: Apr. 2, 2019

(51) Int. Cl. G06Q 30/02; G06F 16/901

(52) U.S. Cl. CPC G06Q 30/0201; G06F 16/9024

(57) ABSTRACT

A computer-implemented system performs slotting (e.g., placement of automotive parts in a warehouse) by identifying communities of object identifiers (e.g., SKUs) of objects (e.g., automotive parts) which are frequently purchased together. Detecting such communities and using them to perform slotting provides advantages over other slotting methods, such as reducing costly and time-consuming sortation and other post-processing steps.

### BACKGROUND

It is desirable in many contexts to arrange objects in a manner that increases the efficiency with which objects may be retrieved. For example, the term “slotting” refers to the process of assigning storage locations to each stock-keeping unit (SKU) in a warehouse. It is desirable to perform slotting in a manner that reduces the total amount of distance covered and/or time spent retrieving objects from the shelves. Doing so can yield substantial savings, particularly if costly sorting or post-processing operations are avoided, because travel time is one of the most expensive operations in the warehouse.

Existing slotting methods include:
Random slotting, in which incoming SKUs are assigned randomly to suitable, available storage locations.
Slotting using turnover-based metrics, in which SKUs are assigned storage locations based on the assumption that frequently-sold items should be located in easily accessible storage locations. Warehouses typically use the “known cube per order index” (COI) rule, which ensures that heavy or frequently-sold SKUs are stored in more desirable locations close to ground level. For example, it may be desirable to store heavy items at hip level and frequently-selling items near a conveyor or close to packing/outbound stations.
Order oriented slotting, in which SKUs are assigned in such a way that the total time needed to pick all the orders is minimized. In order oriented slotting, if a pair of items are part of the same order, then those two items are stored in storage locations that are close to each other, to the extent possible.
SKU affinity slotting, in which SKUs are assigned to storage locations based on an affinity score, such that SKUs that are frequently ordered together are assigned to locations that are near each other.

These existing slotting methods have a variety of disadvantages. In particular, they do not adequately minimize sorting operations, which typically involve identifying items on a conveyor system and diverting them to specific destinations. For example, in the automotive industry, a large number of sales involve long-tail kitting or bundling of SKUs. For example, the same suspension components may be used by multiple year/make/model permutations of vehicles. Although some component types, such as ball joints, may be very popular in aggregate across a plurality of specific SKUs, but most individual ball joints will be sold as parts of orders for particular vehicle models. As a result, although a particular model of ball joint may have frequent sales, each individual sale will be bundled with different components matching a specific vehicle model. If those components are located far from each other in the warehouse, then the time required to pick those components from the shelves may increase from a few minutes to a few hours. If there is a wide variety of infrequently-sold component combinations, this inefficiency can become significant.

As another example, typically only a small number of kits are very popular, as measured by number of sales. The very popular kits, however, often share components with many less popular kits. Yet when the slotting techniques above are used, the components in popular kits and unpopular kits often are slotted far away from each other in the warehouse. Then, if a component in a popular kit and a component in an unpopular kit are sold together, those two components are likely to be far away from each other in the warehouse.

As yet another example, a high percentage of sales often come from kits or bundles sold only once during a 30- or 90-day period. This also leads to components from such kits or bundles being located far in the warehouse from components in more frequently-sold kits or bundles.

As yet another example, for a single vehicle, a customer may purchase a kit containing only two components, or up to N different components (where N may be much greater than two), depending on their repair needs. Yet slotting techniques such as order oriented slotting only takes into account frequent specific orders, and as a result often produces poor results when applied to kits containing a greater number of components than were contained in previous specific orders or shared components across a plurality of orders.

As these examples illustrate, there is a need for improved slotting methods.

### SUMMARY

A computer-implemented system performs slotting (e.g., placement of automotive parts in a warehouse) by identifying communities of object identifiers (e.g., SKUs) of objects (e.g., automotive parts) which are frequently purchased together. Detecting such communities and using them to perform slotting provides advantages over other slotting methods, such as reducing costly and time-consuming sortation and other post-processing steps.

Other features and advantages of various aspects and embodiments of the present invention will become apparent from the following description and from the claims.

### BRIEF DESCRIPTION OF THE DRAWINGS

FIG. 1 is a dataflow diagram of a system for performing slotting according to one embodiment of the present invention;

FIG. 2 is a flowchart of a method performed by the system of FIG. 1 according to one embodiment of the present invention; and

FIG. 3 is a flowchart of a method for generating a weighted retail graph according to one embodiment of the present invention.

### DETAILED DESCRIPTION

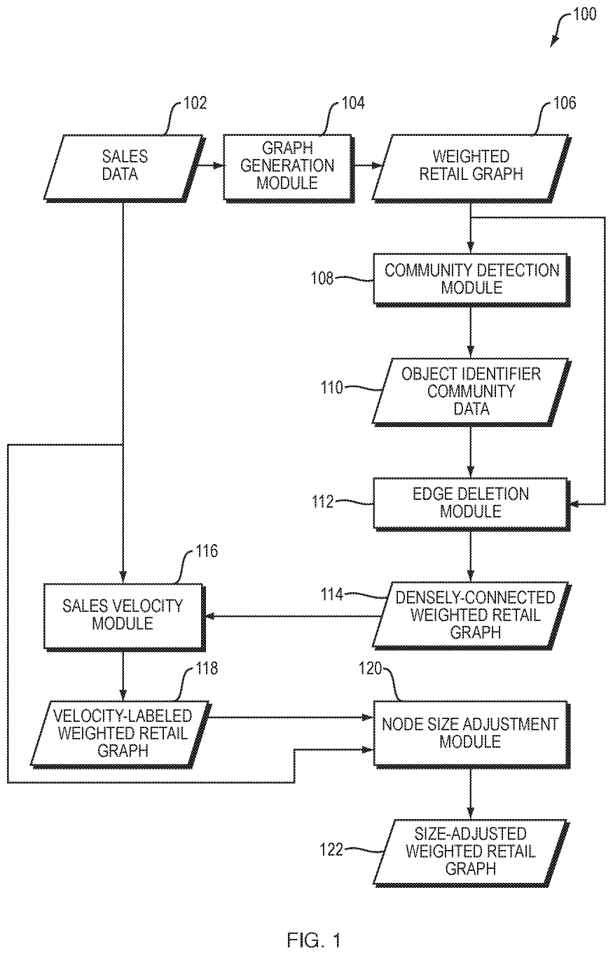

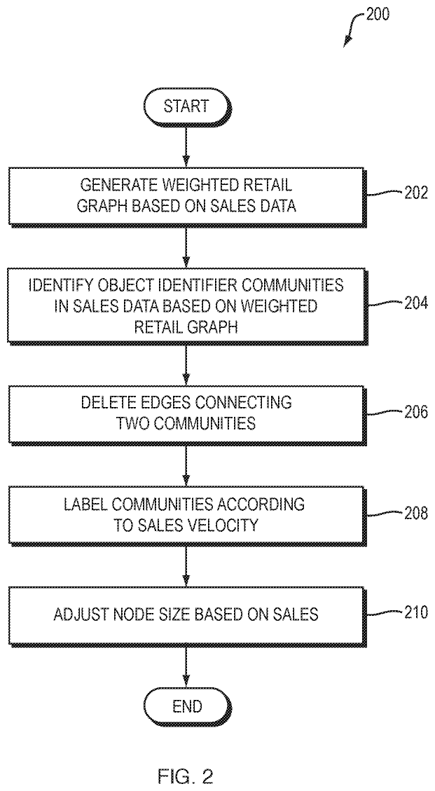

Embodiments of the present invention are directed to computer-implemented methods and systems for assigning storage locations to objects (also referred to as “slotting”), e.g., in a warehouse, in order to minimize sortation required to fulfill a request for a particular set of objects (e.g., kits or bundles). Referring to FIG. 1 a dataflow diagram is shown of a system 100 for performing slotting according to one embodiment of the present invention. Referring to FIG. 2, a flowchart is shown of a method 200 performed by the system 100 according to one embodiment of the present invention.

Before describing the system 100 and method 200, certain terms will be defined. The term “object,” as used herein, refers to any physical item that may be slotted. Examples of objects include, but are not limited to, products, parts, and components, such as automobile components. Any reference herein to a product, part, component, or similar item should be understood to refer more generally to an “object,” as that term is defined herein.

The term “object identifier” refers to any data that may be used to identify a class of objects. An object is said to “have” or “be associated with” a corresponding object identifier. Any reference herein to an object's object identifier should be understood to refer to the object identifier that is associated with the object.

One non-limiting example of an object identifier is a stock keeping unit (SKU). Any reference herein to an SKU or other particular example of an object identifier should be understood to refer more generally to any kind of object identifier. A particular object identifier (e.g., SKU) may identify a plurality of particular objects. For example, a plurality of spark plugs of the same type may share the same object identifier (e.g., SKU). Any reference herein to slotting or otherwise arranging or selecting a plurality of object identifiers should be understood to refer to one or more of: (1) associating those object identifiers with locations (such as by storing data representing one or more associations between the object identifiers and their associated locations); and (2) physically storing objects having those object identifiers in the locations associated with those object identifiers. For example, slotting an object identifier A and an object identifier B may involve associating object identifier A with a first location and associating object identifier B with a second location that differs from the first location. Such slotting may also include physically storing one or more objects having object identifier A in the first location and physically storing one or more objects having object identifier B in the second location.

The association between any particular object and its object identifier may be implemented in any of a variety of ways, such as any one or more of the following:
physically imprinting, attaching, or otherwise coupling a representation of the object identifier on or to the object, such as by using writing, a tag (e.g., a printed tag or an RFID tag), a plate, a chip, or other human-readable and/or machine-readable storage medium;
physically imprinting, attaching, or otherwise coupling a representation of the object identifier on or to a container that stores the object, such as a shelf, bin, or drawer; and
storing data representing the association between the particular object and its object identifier in computer-readable data stored in a computer-readable medium, such as in a database.

A physical manifestation of an object identifier, such as any of the above examples, is referred to herein as an “object identifier unit.” A single object may be associated with zero, one, or more object identifiers (and their corresponding object identifier units). A single object identifier (and its corresponding object identifier unit) may be associated with zero, one, or more objects.

The term “storage location,” as used herein, refers herein to any physical location in which an object may be stored. Non-limiting examples of storage locations include shelves, bins, and drawers. A storage location may be of any shape and size. For example, a particular storage location may be an entire shelf or only a portion of a shelf. The term “storage location data,” as used herein, refers to any data that may be used to identify a storage location. Non-limiting examples of storage location data include, individually or in any combination, Global Positioning System (GPS) coordinates; shelf, bin, or drawer numbers; and data defining a three-dimensional volume.

The term “order,” as used herein, refers to data that identifies one or more objects. An order may, for example, include data identifying a set of objects that have been purchased in combination with each other and/or a set of objects to be picked from their storage locations. An order may identify the object(s) it contains in any way, such as by using the object's object identifiers. As a particular example, an order may identify the orders it contains using a list of object identifiers and corresponding quantities. For example, an order that includes object identifier A and corresponding quantity X indicates X objects having object identifier A should be picked from their storage locations.

The term “pick,” as used herein, refers to the act of physically removing an object from its storage location.

Referring again to FIGS. 1 and 2, the system 100 may include sales data 102. The sales data 102 may include any of a variety of data representing one or more orders. Each such order may, for example, include or be associated with data representing a date, such as a date on which the order was placed and/or fulfilled. The sales data 102 may, for example, include a statistically significant amount of data, such as sales data covering a time period including at least 90 days.

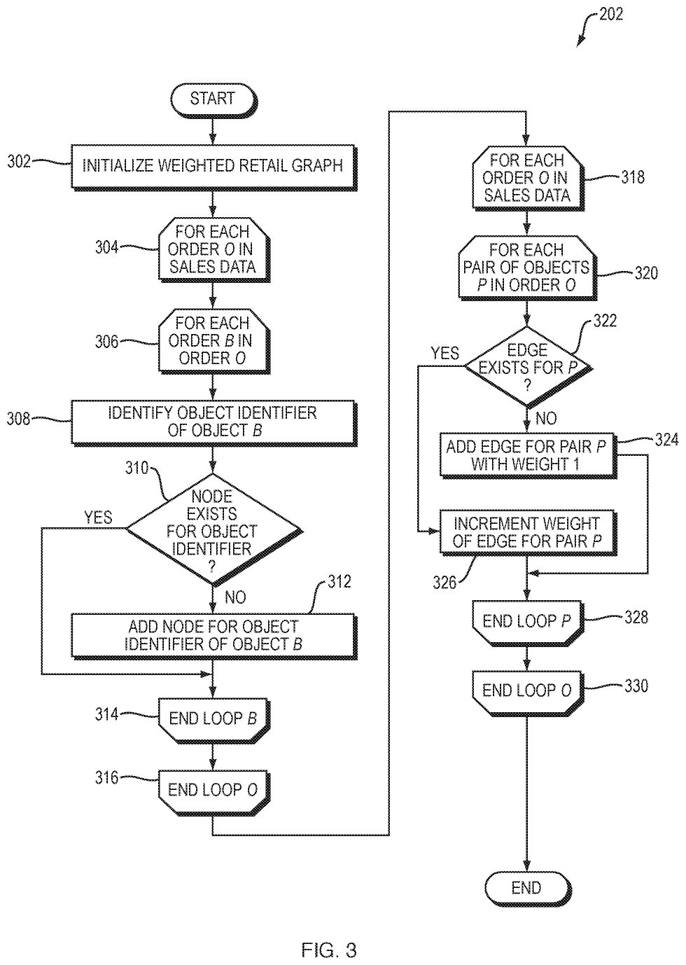

The system 100 also includes a graph generation module 104, which receives the sales data 102 as input and which generates a weighted retail graph 106 as output based on the sales data 102 (FIG. 2, operation 202). As described above, each of the orders in the sales data 102 may include data identifying one or more objects, such as by using the objects' SKUs or other object identifiers. The graph generation module 104 may, for example, generate the weighted retail graph 106 based on the sales data 102 in the manner shown in FIG. 3. The graph generation module 104 may initialize the weighted retail graph 106, such as by generating an empty graph, i.e., a graph consisting of zero nodes and zero edges (FIG. 3, operation 302). The graph generation module 104 may then enter a loop over each order O in the sales data 102 (FIG. 3, operation 304). The graph generation module 104 may then enter a loop over each object B in the order O (FIG. 3, operation 306).

The graph generation module 104 identifies the object identifier (e.g., SKU) of object B, such as by retrieving the object identifier associated with object B in the sales data 102 (FIG. 3, operation 308). The graph generation module 104 determines whether the weighted retail graph 106 contains a node for the object identifier of object B (FIG. 3, operation 310). If the weighted retail graph 106 does not contain a node for the object identifier of object B, then the graph generation module 104 creates a node for the object identifier of object B and adds that node to the weighted retail graph 106 (FIG. 3, operation 312).

The graph generation module 104 repeats operations 308-312 for the remaining objects in the order O (FIG. 3, operation 314), and thereby adds nodes as necessary to the weighted retail graph 106 for the object identifiers of all objects in the order O. The graph generation module 104 repeats operations 306-314 for the remaining orders in the sales data 102 (FIG. 3, operation 316), and thereby adds nodes as necessary to the weighted retail graph 106 for the object identifiers of all objects in all of the orders in the sales data 102.

For each pair of object identifiers contained in each order in the sales data 102, the graph generation module 104 creates an edge with a weight that is equal to the number of pairs of object identifiers in the sales data 102 corresponding to the nodes connected by that edge, such as by performing the following operations. The graph generation module 104 enters a loop over all orders O in the sales data 102 (FIG. 3, operation 318). The graph generation module 104 enters a loop over each pair P of object identifiers in the order O (FIG. 3, operation 320). The graph generation module 104 determines whether the weighted retail graph 106 contains an edge representing pair P (i.e., an edge that connects nodes representing the two objects in pair P) (FIG. 3, operation 322). If the weighted retail graph 106 does not contain an edge representing pair P, then the graph generation module 104 creates an edge representing pair P with a weight of 1 and adds that edge to the weighted retail graph 106 (FIG. 3, operation 324). If the weighted retail graph 106 does contain an edge representing pair P, then the graph generation module 104 increments the existing weight of that edge (FIG. 3, operation 326).

The graph generation module 104 repeats operations 322-326 for the remaining object pairs in the order O (FIG. 3, operation 328), and thereby adds edges as necessary to the weighted retail graph 106 for all pairs of objects in the order O. The graph generation module 104 repeats operations 320-328 for the remaining orders in the sales data 102 (FIG. 3, operation 330), and thereby adds edges as necessary to the weighted retail graph 106 for all pairs of objects in all of the orders in the sales data 102. The end result of the process shown in FIG. 3. is the weighted retail graph 106 shown in FIG. 1.

The weighted retail graph 106, as the result of the process shown in FIG. 3, contains a node for each object in the sales data 102, an edge for each pair of objects in the sales data 102 that have been sold together (i.e., that appear in at least one order together), and a weight for each edge connecting two objects A and B, where the weight is equal to (or otherwise a function of) the number of times objects A and B have been sold together, as indicated by the sales data 102.

Returning to FIG. 1, the system 100 also includes a community detection module 108, which receives the weighted retail graph 106 as input and which identifies, based on the weighted retail graph 106, one or more communities (i.e., sets) of object identifiers (e.g., SKUs) in the weighted retail graph 106, which are also communities of object identifiers in the sales data 102 (FIG. 2, operation 204). The community detection module 108 generates, as output, object identifier community data 110 representing the identified communities of object identifiers.

The object identifier community data 110 may represent any number of object identifier communities, such as one, two, three, or more object identifier communities. In practice the object identifier community data 110 may, for example, represent hundreds or more object identifier communities. Each such object identifier community includes a subset of the object identifiers from the weighted retail graph 106. Any two object identifier communities may be disjoint or may overlap with each other in any way. For example, any pair of object identifier communities may contain distinct subsets of the object identifiers in the weight retail graph 106. As another example, any pair of object identifier communities may contain some, but not all, object identifiers in common with each other.

Each of the communities 110 may contain any number of object identifiers, such as one, two, three, four, or more object identifiers. A community may contain a large number of object identifiers, such as at least 10, at least 20, at least 50, or at least 100 object identifiers. Different ones of the communities 110 may contain different numbers of object identifiers. For example, one of the communities 110 may contain three object identifiers while another one of the communities may contain five object identifiers.

Furthermore, one or more of the communities 110 may contain more objects than are contained in any individual order in the sales data 102. For example, even if the sales data 102 only contains orders containing at most three objects, the communities 110 may contain a community that includes four (or more objects).

Furthermore, consider a scenario in which the sales data 102 includes the following orders:
an order consisting of SKUs A+B is sold 20 times;
an order consisting of SKUs B+C is sold 18 times;
an order consisting of SKUs C+D is sold 5 times;
an order consisting of SKUs C+E is sold 5 times;
an order consisting of SKUs C+F is sold 5 times;
an order consisting of SKUs A+B+C+D+E is sold 1 time; and
an order consisting of SKUs A+B+C+D+F is sold 1 time.

As can be seen above, SKU D is sold a relatively small number of times and is always sold in an order that also contains SKU C. In this scenario, embodiments of the present invention may slot the following SKUs together, even though those SKUs never appeared in a single order together in the sales data 102: SKUs A+B+C+D+E+F.

In contrast, order oriented slotting would not slot SKUs A+B+C+D+E+F together, because order oriented slotting ignores SKUs having a sales frequency which falls below some threshold (e.g. <10 times), or will prioritize slotting only specific pairs in this instance. In the example above, SKU C is sold 17 times, but would usually be slotted far from each pair of D, E, and F by order oriented slotting, because sales of those pairs or the larger kits do not satisfy a sales frequency threshold.

The community detection module 108 may identify the object identifier communities 110 in any of a variety of ways, such as by using the Louvain Method. In the Louvain method, the value to be optimized is modularity, defined as a value between −1 and 1 that measures the density of links inside communities compared to the densities of links between communities. For a weighted graph, modularity is defined as

$$Q = \frac{1}{2 m} {\sum }_{ij} [ {A}_{i j} - \frac{{k}_{i} {k}_{j}}{2 m} ] δ ( {c}_{i} , {c}_{j} ) ,$$

where
Aᵢⱼ represents the edge weight between nodes i and j;
kᵢ and kⱼ are the sum of the weights of the edges attached to nodes i and j, respectively;
2m is the sum of all of the edge weights in the graph;
cᵢ and cⱼ are the communities of the nodes; and
δ is a simple delta function.

The manner of operation of the Louvain Method is well-known to those having ordinary skill (although the application of the Louvain Method within embodiments of the present invention is not known to those having ordinary skill in the art) and is not described in detail herein. Furthermore, the Louvain Method is merely one method that may be used to implement a community detection algorithm within embodiments of the present invention to generate the object identifier community data 110, and does not constitute a limitation of the present invention. Other examples of community detection algorithms that may be used by embodiments of the present invention include, but are not limited to: the Girvan-Newman algorithm (as described, e.g., in M. Girvan and M. E. J. Newman, “Community structure in social and biological networks,” PNAS, vol. 99, no. 12, pp. 7821-7826, Jun. 11, 2012); the label propagation algorithm (as described, e.g., in X. Zhu and Z. Ghahramani, “Learning from Labeled and Unlabeled Data with Label Propagation,” CMU School of Computer Science, CMU-CALD-02-107, June 2002); the walktrap algorithm (as described, e.g., in P. Pons and M. Latapy, “Computing communities in large networks using random walks”); a random walks algorithm, and an edge betweenness algorithm.

The system 100 also includes an edge deletion module 112, which deletes edges in the weighted retail graph 106 that connect two communities to each other (FIG. 2, operation 206). The edge deletion module 112 may, for example, identify some or all of the edges in the weighted retail graph 106 that connect two communities (as represented by the object identifier community data 110) and then delete the identified edges or otherwise label the identified edges as connecting two communities so that those edges can be ignored when performing slotting, thereby resulting in a densely-connected weighted retail graph 114. Such deletion (or nonuse) of edges that connect communities has the effect of creating densely-connected communities of object identifiers.

The system 100 also includes a sales velocity module 116, which assigns and stores labels to communities in the graph 114 based on sales velocity (as reflected in the sales data 102), thereby producing a velocity-labeled weighted retail graph 118 (FIG. 2, operation 208). The term “sales velocity,” as used herein in connection with an object identifier community, refers to the frequency of sales of objects within that community. For example, an object identifier community representing objects that sell relatively frequently is said to have a higher sales velocity than an object identifier community representing objects that sell relatively infrequently. The label that is assigned to each community by the sales velocity module 116 represents a sales velocity of that community. Although not shown in FIG. 2, embodiments of the present invention may sort the object identifiers within one or more of the communities in the velocity-labeled weighted retail graph 118, such as by using any of a variety of traditional turnover metrics, such as sales velocity or COI and constraints by weight/space availability.

The system 100 also includes a node size adjustment module 120, which adjusts the size of nodes in the graph 118 based on sales velocity (as reflected in the sales data 102), thereby producing a size-adjusted weighted retail graph 122 (FIG. 2, operation 208).

Embodiments of the present invention may use the size-adjusted weighted retail graph 122 to perform slotting. In particular, the communities in the graph 122 may be used to perform slotting, such that objects having the object identifiers in the communities in the graph 122 are slotted near each other, to the extent possible. Any of a variety of slotting techniques, such as well-known techniques, may be applied to the size-adjusted weighted retail graph 122 to perform slotting on the object identifiers in the size-adjusted weighted retail graph (even though it is not known to generate the size-adjusted weighted retail graph 122 or to use the size-adjusted weighted retail graph 122 for slotting).

Not all of the operations shown in FIG. 2 need be performed. If any of the operations shown in FIG. 2 are omitted, then slotting may be performed based on the graph that exists at any stage in the method 200 of FIG. 2. For example, if operation 210 is omitted and the size-adjusted weighted retail graph is not generated, then embodiments of the present invention may perform slotting on the velocity-labeled weighted retail graph. As another example, if operation 208 is omitted and the velocity-labeled weighted retail graph 118 is not generated, then embodiments of the present invention may perform slotting based on the densely-connected weighted retail graph 114. As another example, embodiments of the present invention may perform slotting based on the object identifier community data.

One advantage of embodiments of the present invention, in contexts such as automotive parts retail, is that they may be used to increase or maximize warehouse productivity by storing closely-related parts near each other. The closeness of relation between any two parts may, for example, be measured based on the frequency with which those two parts are sold together (e.g., as part of the same order). Embodiments of the present invention help to avoid sortation, which dramatically increases an order cycle time.

In contrast, most slotting processes use turnover-based metrics. Some newer slotting methods use order velocity. In contrast, embodiments of the present invention assign slots based on a community of closely-related SKUs, thereby dramatically reducing the need for lengthy sortation processes for complex kitting.

Experimentation with embodiments of the present invention has shown that the communities generated in the graph 122 tend to correspond to common vehicle components across several makes/models. Community detection, as performed by embodiments of the present invention, enables “one-off” sales of non-highly connected object identifiers to be ignored, while still keeping “one-off” sales of a kit of 18 highly connected components.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may be applied to datasets (e.g., the sales data 102) containing, thousands, millions, or more data elements and produce the final graph 122 in a few seconds, whereas it would be prohibitively time-consuming for a human to attempt to produce the final graph 122 based on such a volume of sales data.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) receiving sales data representing a plurality of orders, wherein each of the plurality of orders includes a corresponding plurality of objects;
(B) generating a weighted graph based on the sales data, wherein the weighted graph includes: (1) a node corresponding to each of the plurality of objects in the plurality of orders; and (2) for each pair of nodes corresponding to a pair of objects contained within a common order, a corresponding edge connecting that pair of nodes; and (3) for each edge, a corresponding weight representing a number of times the objects represented by the nodes connected by the edge are contained in any order together;
(C) generating, based on the weighted graph, object identifier community data representing at least one subset of at least three object identifiers in the weighted graph; and
(D) performing slotting based on the object identifier community data, wherein slotting comprises associating, with each of the object identifiers in the object identifier community data, a corresponding location.

2. The method of claim 1, wherein (C) comprises generating the weighted graph by applying a community detection algorithm.

3. The method of claim 2, wherein the community detection algorithm comprises one of the Louvain Method, a label propagation algorithm, a walktrap algorithm, a random walks algorithm, an edge betweenness algorithm, and the Girvan-Newman algorithm.

4. The method of claim 1, wherein the at least one set of object identifiers comprises at least one set of stock keeping units (SKUs).

5. The method of claim 1, further comprising:
(E) before (D), deleting edges connecting pairs of communities to each other in the object identifier community data.

6. The method of claim 1, further comprising:
(E) before (D), assigning sales velocity data to each of the plurality of communities, wherein the sales velocity data represents frequency of sales of objects in the plurality of communities; and
wherein (D) comprises performing slotting based on the object identifier community data and at least one turnover-based metric.

7. The method of claim 6, wherein the at least one turnover-based metric includes object sales.

8. The method of claim 6, wherein the at least one turnover-based metric includes object weight.

9. The method of claim 6, wherein the at least one turnover-based metric includes object size.

10. The method of claim 6, wherein the at least one turnover-based metric includes object cube-per-order index.

11. A system comprising at least one non-transitory computer-readable medium having computer program instructions stored thereon, the computer program instructions being executable by at least one computer processor to perform a method, the method comprising:
(A) receiving sales data representing a plurality of orders, wherein each of the plurality of orders includes a corresponding plurality of objects;
(B) generating a weighted graph based on the sales data, wherein the weighted graph includes: (1) a node corresponding to each of the plurality of objects in the plurality of orders; and (2) for each pair of nodes corresponding to a pair of objects contained within a common order, a corresponding edge connecting that pair of nodes; and (3) for each edge, a corresponding weight representing a number of times the objects represented by the nodes connected by the edge are contained in any order together;
(C) generating, based on the weighted graph, object identifier community data representing at least one subset of at least three object identifiers in the weighted graph; and
(D) performing slotting based on the object identifier community data, wherein slotting comprises associating, with each of the object identifiers in the object identifier community data, a corresponding location.

12. The system of claim 11, wherein (C) comprises generating the weighted graph by applying a community detection algorithm.

13. The system of claim 12, wherein the community detection algorithm comprises one of the Louvain Method, a label propagation algorithm, a walktrap algorithm, a random walks algorithm, an edge betweenness algorithm, and the Girvan-Newman algorithm.

14. The system of claim 11, wherein the at least one set of object identifiers comprises at least one set of stock keeping units (SKUs).

15. The system of claim 11, wherein the method further comprises:
(E) before (D), deleting edges connecting pairs of communities to each other in the object identifier community data.

16. The system of claim 11, wherein the method further comprises:
(E) before (D), assigning sales velocity data to each of the plurality of communities, wherein the sales velocity data represents frequency of sales of objects in the plurality of communities; and
wherein (D) comprises performing slotting based on the object identifier community data and at least one turnover-based metric.

17. The system of claim 16, wherein the at least one turnover-based metric includes object sales.

18. The system of claim 16, wherein the at least one turnover-based metric includes object weight.

19. The system of claim 16, wherein the at least one turnover-based metric includes object size.

20. The system of claim 16, wherein the at least one turnover-based metric includes object cube-per-order index.
